(19) United States
(12) Patent Application Publication
(10) Pub. No.: US 2008/0135502 A1
(43) Pub. Date: Jun. 12, 2008

(54) BLOOD PLASMA SEPARATOR EMPLOYING MICRO CHANNEL AND BLOOD PLASMA SEPARATION METHOD THEREOF

(75) Inventors: Hyeon-Bong PYO, Daejon (KR); Kwang-Hyo CHUNG, Daejon (KR); Young-Jun KIM, Daejon (KR); Se-Ho PARK, Daejon (KR); Seon-Hee PARK, Daejon (KR); Won-Ick JANG, Daejon (KR); Dae-Sik LEE, Daejon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejon (KR)

(21) Appl. No.: 11/929,800

(22) Filed: Oct. 30, 2007

(30) Foreign Application Priority Data
Dec. 7, 2006 (KR) 1020060124030

(51) Int. Cl. B01D 21/28; B01D 21/00; B01D 21/34; B01D 21/26

(52) U.S. Cl. 210/801; 210/137; 210/512.1; 210/85

(57) ABSTRACT

Provided is a blood plasma separator for separating blood plasma and blood cells from whole blood without an additional complicated structure by passing the whole blood through a micro channel having a predetermined shape to make the whole blood flow turbulently and cause a velocity difference or deflection between flows of the blood plasma and the blood cells of the whole blood, and a blood plasma separation method thereof. The blood plasma separator includes: a body; a micro channel formed in the body to allow blood to pass therethrough; a separation member formed at the micro channel to make flow of blood cells or blood plasma turbulent to separate the blood cells from the blood plasma; an inlet connected to the micro channel and configured to introduce blood into the micro channel; and an outlet connected to the micro channel and configured to discharge blood from the micro channel.

### CROSS-REFERENCE(S) TO RELATED APPLICATIONS

The present invention claims priority of Korean Patent Application No. 10-2006-0124030, filed on Dec. 7, 2006, which is incorporated herein by reference.

### BACKGROUND OF THE INVENTION

1. Field of the Invention

The present invention relates to a blood plasma separator for separating blood plasma from whole blood and a method of separating blood plasma using the blood plasma separator; and, more particularly, to a blood plasma separator for separating blood plasma and blood cells from whole blood without an additional complicated structure or device by passing the whole blood through a micro channel having a predetermined shape or layout to make the whole blood flow turbulently and cause a velocity difference or deflection between flows of the blood plasma and the blood cells of the whole blood, and a method of separating blood plasma using the blood plasma separator.

This work was supported by the Information Technology (IT) research and development program of the Korean Ministry of Information and Communication (MIC) and/or the Korean Institute for Information Technology Advancement (IITA) [2006-S-007-01, “Ubiquitous Health Monitoring Module and System Development”].

2. Description of Related Art

Various biosensors are used for detecting biological information from a biological sample. Such biosensors must have good repeatability for reliable results and good sensitivity for obtaining highly sensitive sensing signals. A biological sample can be pre-processed before the biological sample is supplied to a biosensor to treat the biological sample according to the characteristics of the biosensor so as to increase the repeatability and sensitivity in detection.

Generally, such a pre-process is performed by a skilled and qualified person using various bulky blood analyzing equipment and requires much time and large manpower. However, the amount of a biological sample to be treated in the pre-process is not large (for example, only several thousandth of a liter). Therefore, various pre-processes may be performed depending on the kinds and characteristics of biological samples, and thus it is difficult to perform such pre-processes using a small-sized device. Thus, it is difficult and takes much time to develop biosensors in the form of a lab-on-a-chip in which a pre-processor unit, a reaction unit, and a sensor unit are integrated.

Protein chips, a kind of biochip used in a biosensor, have been developed for detecting a specific protein from a biological sample. Such protein chips are usually used to detect a specific protein from whole blood contains a number of blood cells and blood plasma, including fat, metabolites, water, enzymes, antigens, antibodies, cells, and other protein components. In general, proteins are included in the blood plasma. Therefore, it is necessary to remove blood cells from whole blood prior to detect a protein from the whole blood so as to detect proteins at a good repeatability and sensitivity level.

For this reason, blood plasma separators have been developed. For example, a paper blood plasma separator such as a pregnancy test kit has been developed. However, the paper blood plasma separator is disadvantageous in that it is difficult to precisely control a blood flow, and blood can be contaminated or uselessly consumed. That is, the paper blood plasma separator is not suitable for detecting a small amount of protein at a high sensitivity. Moreover, the paper blood plasma separator is not suitable for an integrated chip, which includes a pre-processor unit, a reaction unit, and a detection unit and performs complicated reactions.

Other examples of blood plasma separators, which can be used in a lap-on-a-chip type biosensor for removing blood cells from whole blood to extract blood plasma, include a blood plasma separator in which a porous medium or a membrane is disposed at a side of a blood flow or in the middle of the blood flow for separating blood cells from whole blood; and a blood plasma separator configured to extract blood plasma from whole blood by allowing the whole blood to be divided into a blood cell layer and a blood plasma layer by sedimentation.

In one example, blood plasma is separated from whole blood without consuming any power by using capillary action. In detail, whole blood is forced by capillary action to pass through a blood extractor, which blood cells cannot pass through but blood plasma can pass through.

In another example, a blood collector, a blood plasma separator, and an analyzer are sequentially disposed, and blood plasma is automatically separated from a blood flow using a centrifugal force. Furthermore, some of channels are adjusted in size to collect blood cells while allowing blood plasma to flow smoothly.

In another example, an electric signal is applied to a blood flow to deflect a flow of blood cells from the blood flow so as to extract blood plasma from whole blood. In detail, long and short pressure pulses are periodically applied to an inlet of a micro channel formed in a biochip to change a flow of blood cells so as to separate blood plasma from whole blood. That is, an additional blood plasma separating structure is not necessary for separating blood plasma from whole blood.

In another example, blood plasma is separated from whole blood using a specific sheet having a stacked structure. In detail, a blood processing/blood plasma separating layer and a sheet-form spacer layer allowing a smoother blood flow than the blood processing/blood plasma separating layer are stacked and rolled, and an end of the sheet-form spacer layer is exposed to the outer peripheral surface of a blood plasma separating material. This example is characterized in that the blood processing/blood plasma separating layer is rolled in spiral form, and a material such as non-woven fabric, woven fabric, a porous sheet is used as the blood plasma separating material.

However, the above-mentioned examples of blood plasma separators require much time for separating blood plasma from whole blood and cannot separate blood plasma continuously and efficiently due to complicated structures and operating mechanism. Furthermore, in the case of using a material such as non-woven fabric, a membrane, or a porous medium, blood cells can be accumulated on the material to close a flow channel. In this case, blood plasma separation cannot be efficiently and continuously performed. Furthermore, owing to above described limitations, it is difficult to develop an integrated biosensor using such blood plasma separators.

### SUMMARY OF THE INVENTION

An embodiment of the present invention is directed to providing a simple, easy-to-make blood plasma separator for automatically separating blood plasma from whole blood without having to use an additional device by simply pumping the whole blood into a micro channel that is configured not to be closed by accumulated blood cells, and a method of separating blood plasma using the blood plasma separator.

In accordance with an aspect of the present invention, there is provided a blood plasma separator for separating blood plasma from blood, the blood plasma separator including: a body; a micro channel formed in the body to allow blood to pass therethrough; a separation member formed at the micro channel to make a flow of blood cells or blood plasma of the blood turbulent so as to separate the blood cells and the blood plasma; an inlet connected to the micro channel and configured to introduce blood into the micro channel; and an outlet connected to the micro channel and configured to discharge blood from the micro channel.

The body may include a cover substrate and a channel substrate that are bonded together, and the micro channel is formed on a plane defined by the cover substrate and the channel substrate.

The micro channel may include a plurality of bent portions to apply a centrifugal force to blood when the blood flows from the inlet to the outlet through the micro channel, a chemically treated portion on an inner surface so as to increase efficiency in separating blood cells and blood plasma, and a complementary capture probe ligand on an inner surface for detecting a predetermined protein from blood plasma.

The separation member may be protruded from an inner wall of the micro channel to cause a velocity difference or deflection between flows of blood cells and blood plasma, and a plurality of separation members may be arranged at the micro channel in a blood flow direction, and rows of the separation members face each other. The rows of the separation members may be symmetrical or asymmetrical with respect to a centerline of a blood flow, and the separation members may decrease or increase in size in the blood flow direction.

The separation member may have a triangular, rectangular, or semicircular shape, and the separation member may be formed to connect mutually facing inner walls of the micro channel so as to cause a velocity difference or deflection between flows of blood cells and blood plasma. The separation members may be arranged at the micro channel in a blood flow direction, and separation members may include sloped or curved surfaces in the blood flow direction to guide blood cells downward or blood plasma upward.

The separation members may have a triangular, trapezoidal, elliptical, or circular shape, and a size about 1/10 to about 10 times that of blood cells, and the micro channel has a width and length about 1 to about 10 times that of blood cells. The separation members may have a size about 1/10 to about 10 times that of blood cells, and the micro channel may have a width and length about 1 to about 10 times that of blood cells.

The outlet may be divided in such a manner that separated blood cells and blood plasma are independently discharged.

The body or the separation member may be formed of one of a plastic material, a silicon material, a glass material, and a rubber material, and the blood plasma separator may further include an analyzer disposed at an end of the micro channel for performing a biochemical reaction or detection using separated blood cells and blood plasma.

In the blood plasma separator, blood may be supplied to the micro channel at a constant or varying flow rate and pressure using a blood supply unit connected to the micro channel to make a flow of blood cells or blood plasma turbulent for facilitating separation of the blood cells and the blood plasma. Herein, the micro channel may be connected to a biosensor for detecting a specific protein from separated blood plasma.

In accordance with another aspect of the present invention, there is provided a method of separating blood plasma from blood using a blood plasma separator including a body, a micro channel formed in the body to allow blood to pass therethrough, and a separation member formed at the micro channel to make a flow of blood cells or blood plasma of the blood turbulent, the method which includes the step of: causing blood cells and blood plasma of blood to flow in the micro channel at different velocities or in different deflection directions by using the separation member formed in the micro channel or on an inner wall of the micro channel so as to separate the blood cells and the blood plasma.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a schematic view illustrating a blood plasma separator in accordance with a first embodiment of the present invention.

FIG. 2A is a schematic view illustrating a change of a blood flow caused by a separation member in a micro channel of FIG. 1.

FIG. 2B is a schematic view illustrating a blood cell confined in an eddy created by the separation member in the micro channel of FIG. 1.

FIG. 3A is a schematic view illustrating separation members formed in the micro channel of FIG. 1 in accordance with an embodiment of the present invention.

FIG. 3B is a schematic view illustrating separation members formed in the micro channel of FIG. 1 in accordance with another embodiment of the present invention.

FIG. 3C is a schematic view illustrating separation members formed in the micro channel of FIG. 1 in accordance with another embodiment of the present invention.

FIG. 4A is a schematic view illustrating exemplary arrangement of separation members in the micro channel of FIG. 1 in accordance with an embodiment of the present invention.

FIG. 4B is a schematic view illustrating exemplary arrangement of separation members in the micro channel of FIG. 1 in accordance with another embodiment of the present invention.

FIG. 4C is a schematic view illustrating exemplary arrangement of separation members in the micro channel of FIG. 1 in accordance with another embodiment of the present invention.

FIG. 5 is a schematic view illustrating a blood plasma separator in accordance with a second embodiment of the present invention.

FIG. 6 is a schematic view illustrating a change of a blood flow caused by separation members in a micro channel of FIG. 5.

FIG. 7A is a schematic view illustrating separation members formed in the micro channel of FIG. 5 in accordance with an embodiment of the present invention.

FIG. 7B is a schematic view illustrating separation members formed in the micro channel of FIG. 5 in accordance with another embodiment of the present invention.

FIG. 7C is a schematic view illustrating separation members formed in the micro channel of FIG. 5 in accordance with another embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

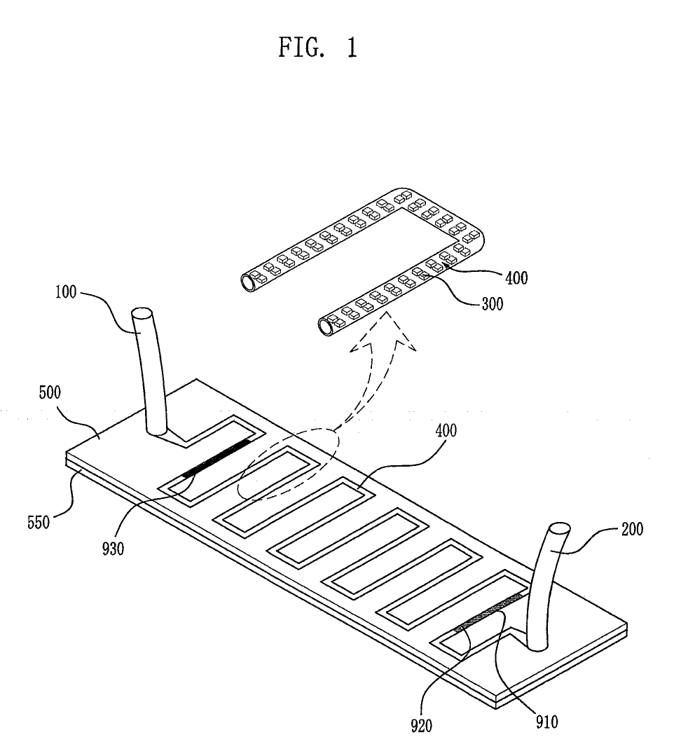

FIG. 1 is a schematic view illustrating a blood plasma separator in accordance with a first embodiment of the present invention.

Referring to FIG. 1, the blood plasma separator of the current embodiment is configured to separate blood plasma from whole blood. The blood plasma separator includes a body, a micro channel 400, and separation members 300. The micro channel 400 is formed in the body as a flow passage for blood 930. The separation members 300 are formed in the micro channel 400 to make a flow of the blood 930 turbulent so as to separate blood cells and blood plasma of the blood 930.

Furthermore, in accordance with an embodiment of the present invention, there is provided a method of separating blood plasma from whole blood using a blood plasma separator such as the blood plasma separator of FIG. 1. In the method, the separation members 300 are used to cause blood cells and blood plasma to flow at different velocities or directions (deflection) so as to separate the blood cells and the blood plasma. For this, the separation members 300 may be formed on an inner wall of the micro channel 400 or disposed inside the micro channel 400.

In the first embodiment of the present invention, the body of the blood plasma separator includes a cover substrate 500 and a channel substrate 550 that are bonded together. The micro channel 400 can be easily formed by defining a trench along a two-dimensional plane formed between the cover substrate 500 and the channel substrate 550. In the current embodiment, the micro channel 400 (a trench) is formed in the channel substrate 550.

However, the micro channel 400 can be formed in at least one of the cover substrate 500 and the channel substrate 550. The body of the blood plasma separator further includes an inlet 100 for receiving the blood 930 and an outlet 200 for discharging the blood 930. The inlet 100 and the outlet 200 are connected to each other through the micro channel 400 so that the blood 930 can flow from the inlet 100 to the outlet 200 through the micro channel 400.

In the blood plasma separator in accordance with the first embodiment of the present invention, the blood 930 is introduced into the micro channel 400 through the inlet 100 by external pumping, and then is separated into blood cell concentration liquid 910 and blood plasma 920 while passing through the micro channel 400 where the separation members 300 are formed. The separation members 300 will now be described in more detail.

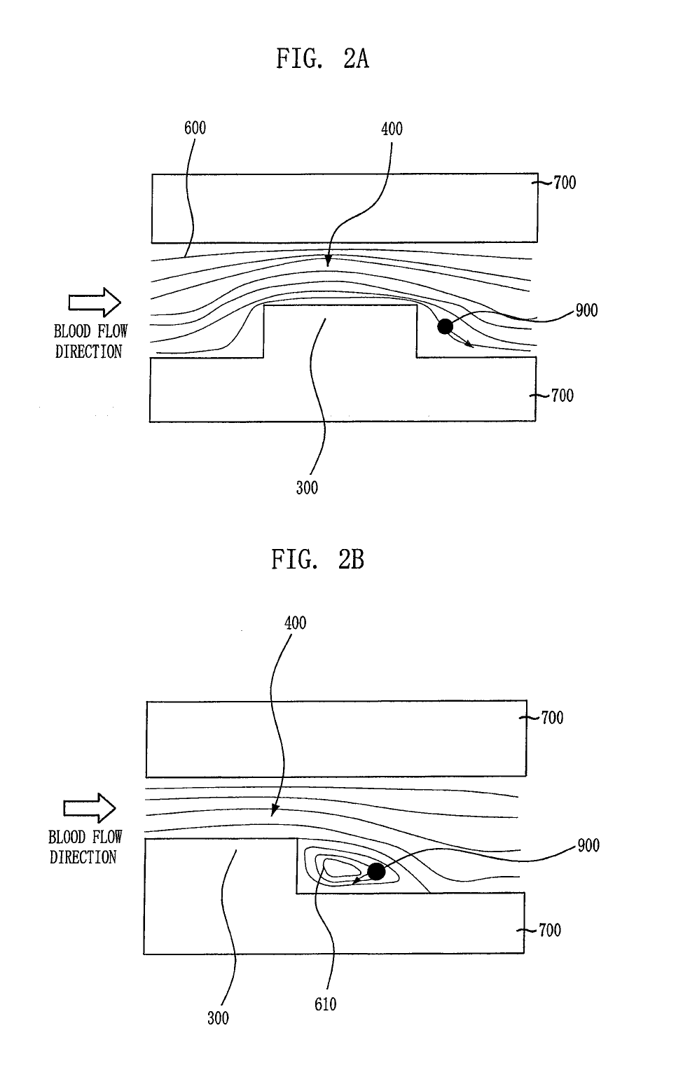

FIG. 2A is a schematic view illustrating a change of a blood flow caused by the separation member 300 in the micro channel 400 depicted in FIG. 1, and FIG. 2B is a schematic view illustrating a blood cell 900 confined in an eddy created by the separation member 300 in the micro channel 400 depicted in FIG. 1.

Referring to FIGS. 2A and 2B, the separation member 300 is protruded from an inner wall 700 of the micro channel 400 so as to cause the blood cell 900 to flow at a speed different from that of blood plasma or in a direction different from that of a flow of the blood plasma (flow deflection).

FIG. 2A illustrates streamlines 600 of blood and a traveling path of the blood cell 900 in the micro channel 400. After passing by the separation member 300, the blood is separated into blood cell concentration liquid 910 and blood plasma 920. In the blood cell concentration liquid 910, most blood cells are contained. Factors that cause flow velocity difference or flow deflection in the micro channel 400 will now be described in more detail.

In the micro channel 400, the velocity of blood is relatively higher at the separation member 300 than at the other portions since the cross-sectional area of the micro channel 400 decreases at the separation member 300.

Therefore, in the micro channel 400, the blood flow is accelerated at the separation member 300. In this case, since the blood cell 900 has a density (or inertia) different from that of the blood plasma 920, the blood cell 900 flows at a speed different from that of the blood plasma 920 or in a direction different from that of a flow of the blood plasma 920.

Referring to FIG. 2B, fewer streamlines 600 are present in the micro channel 400 as compared with the case of FIG. 2A. That is, if the flowrate of blood is the same, the velocity of blood is higher in the case of FIG. 2B than in the case of FIG. 2A. An eddy 610 is generated at a backside of the separation member 300 (a right side of the separation member 300 in FIG. 2B).

Therefore, the velocity or deflection direction of the blood cell 900 is different from that of blood plasma, and this difference varies according to a relationship between the sizes of the blood cell 900 and the eddy 610. In this case, the blood cell 900 may rotate in the eddy 610 and be confined in the eddy 610. That is, the blood cell 900 cannot flow together with a flow of blood in the micro channel 400 due to the eddy 610 generated by the separation member 300.

Furthermore, in the micro channel 400 illustrated in FIGS. 2A and 2B, deformation characteristics of the blood cell 900 are different from those of blood plasma since the blood cell 900 is solid and the plasma is liquid. This causes the blood cell 900 move at an angular velocity different from that of the blood plasma, thereby increasing the velocity difference or the deflection angle between the blood cell 900 and the blood plasma.

Owing to these factors, the blood 930 can be separated into blood plasma 920 and the blood cell concentration liquid 910 in which blood cells are concentrated.

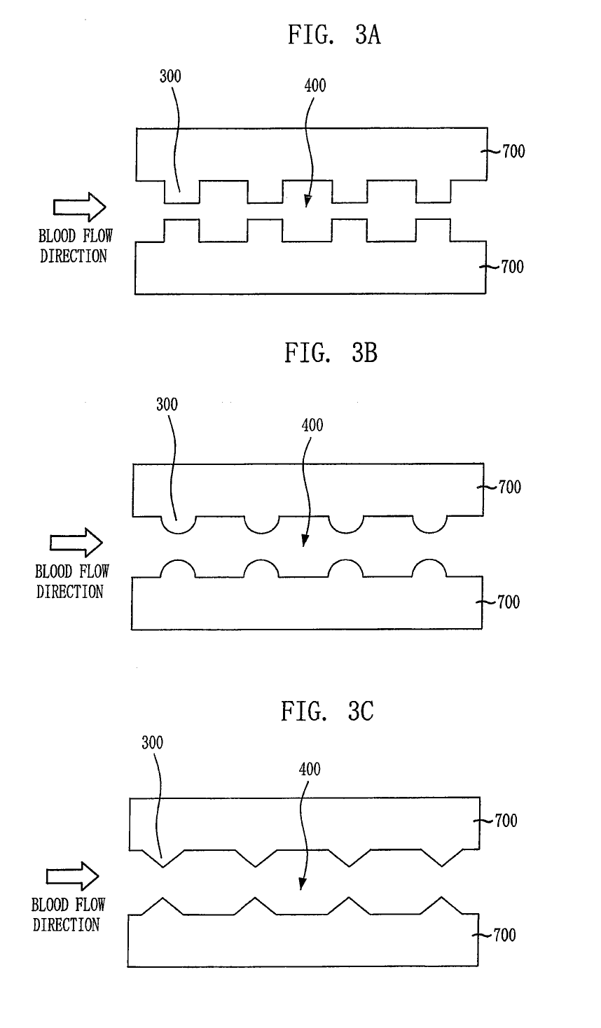

FIG. 3A is a schematic view illustrating separation members 300 formed in the micro channel 400 of FIG. 1 in accordance with an embodiment of the present invention; FIG. 3B is a schematic view illustrating separation members 300 formed in the micro channel 400 of FIG. 1 in accordance with another embodiment of the present invention; and FIG. 3C is a schematic view illustrating separation members 300 formed in the micro channel 400 of FIG. 1 in accordance with another embodiment of the present invention.

Referring to FIGS. 3A to 3C, the separation members 300 are formed in the micro channel 400 in two rows along a blood flow direction, and rows of the separation members 300 face each other so that when blood flows along the micro channel 400, blood cells can be continuously and efficiently separated from blood plasma.

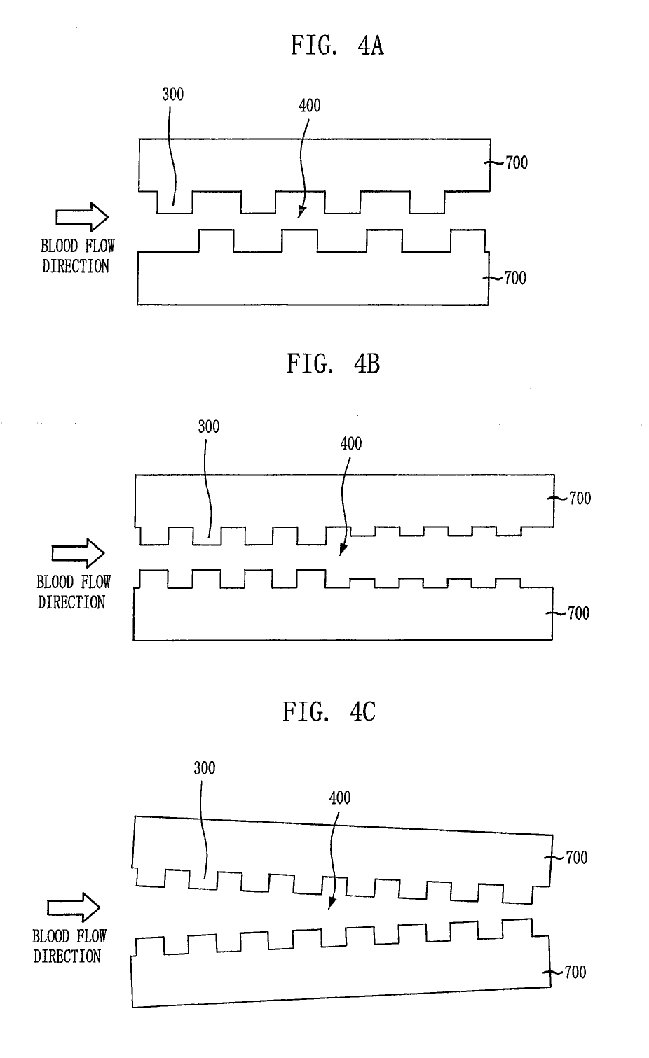

The separation members 300 can have various shapes such as triangular, rectangular, and semicircular shapes so as to maximize efficiency in separating blood cells from blood plasma. As shown in FIGS. 3A, 3B, 3C, 4B, and 4C, the separation members 300 can be symmetrically formed along both sides of the micro channel 400.

FIG. 4A is a schematic view illustrating exemplary arrangement of separation members 300 in the micro channel 400 of FIG. 1 in accordance with an embodiment of the present invention, FIG. 4B is a schematic view illustrating exemplary arrangement of separation members 300 in the micro channel 400 of FIG. 1 in accordance with another embodiment of the present invention, and FIG. 4C is a schematic view illustrating exemplary arrangement of separation members 300 in the micro channel 400 of FIG. 1 in accordance with another embodiment of the present invention.

Referring to FIG. 4A, the separation members 300 are asymmetrically formed along both sides of the micro channel 400. Referring to FIG. 4B, the size of the separation members 300 decreases in a blood flow direction. Alternatively, the size of the separation members 300 can increase in the blood flow direction.

Referring to FIG. 4C, the width of the micro channel 400 can decrease in the blood flow direction. Alternatively, the width of the micro channel 400 can increase in the blood flow direction. Alternatively, the inner wall of the micro channel 400 can be periodically curved in the blood flow direction so that heavier blood cells can be efficiently separated from blood plasma by a centrifugal force.

Meanwhile, as shown in FIG. 1, the micro channel 400 connected between the inlet 100 and the outlet 200 can have a twisted shape such as a serpentine shape and a three-dimensional spiral shape (not shown) so as to maximize efficiency in separating blood cells and blood plasma when blood passes through the micro channel 400.

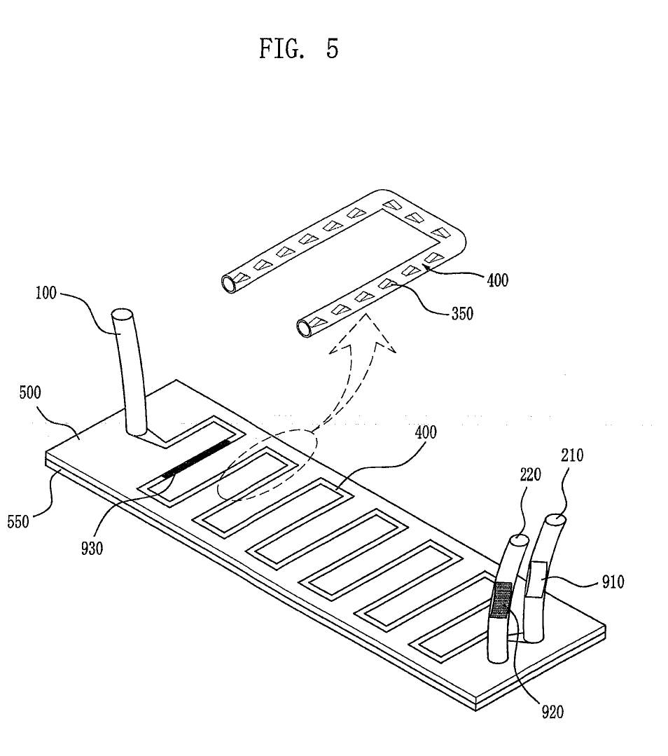

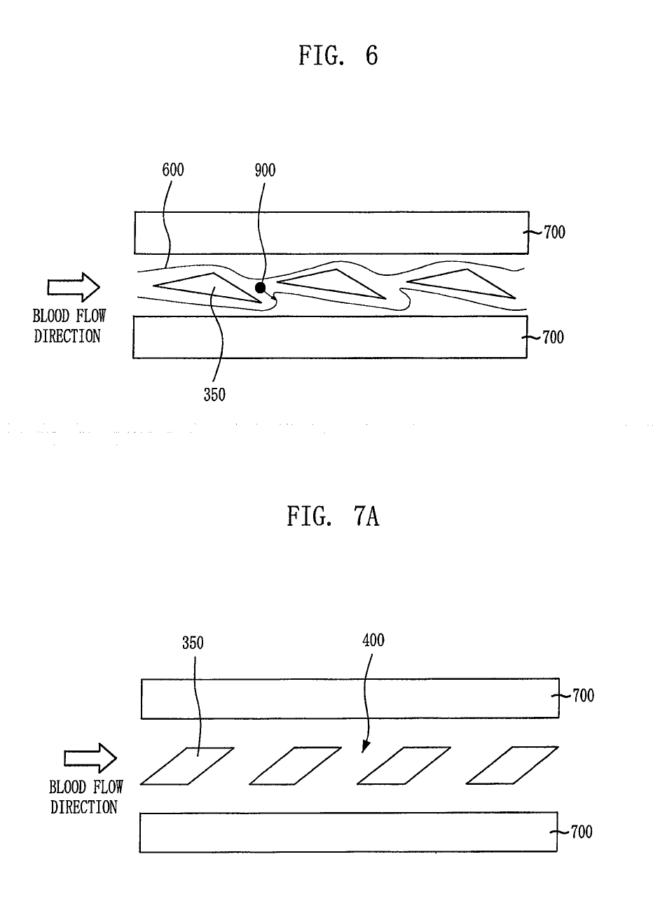

FIG. 5 is a schematic view illustrating a blood plasma separator in accordance with a second embodiment of the present invention, and FIG. 6 is a schematic view illustrating a change of a blood flow caused by separation members 350 in a micro channel 400 of FIG. 5.

Referring to FIGS. 5 and 6, the separation members 350 are formed in the micro channel 400 to connect mutually facing inner walls of the micro channel 400 so as to cause a flow velocity difference or flow deflection between blood cells 900 and blood plasma 920. The separation members 350 are arranged in the micro channel 400 along a blood flow direction so that the blood cells 900 and the blood plasma 920 can be continuously separated.

In addition, the separation members 350 have sloped or curved surfaces in the blood flow direction so that the blood cells 900 can be guided downward or the blood plasma can be guided upward. In other words, when blood 930 flows in the micro channel 400, a stream of the blood 930 is divided into upper and lower streams by the sloped or curved surfaces of the separation members 350.

Herein, the divided streams of the blood 930 receive different flow resistances since upper and lower surfaces of the separation members 350 are asymmetric, and thus the streams of the blood 930 have different velocities or deflection directions (i.e., the streams of the blood 930 become turbulent). Therefore, blood cells 900 can be separated from blood plasma 920 owing to a difference in acceleration or inertia, or eddies formed at backsides of the separation members 350.

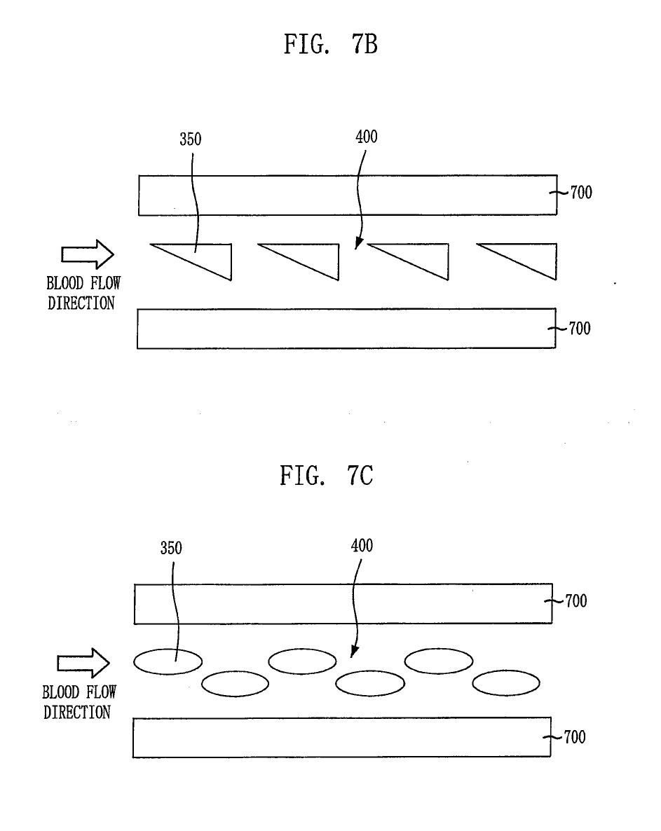

FIG. 7A is a schematic view illustrating separation members 350 formed in the micro channel 400 of FIG. 5 in accordance with an embodiment of the present invention, FIG. 7B is a schematic view illustrating separation members 350 formed in the micro channel 400 of FIG. 5 in accordance with another embodiment of the present invention, and FIG. 7C is a schematic view illustrating separation members 350 formed in the micro channel 400 of FIG. 5 in accordance with another embodiment of the present invention.

To maximize separation efficiency, the separation members 350 can have a trapezoidal shape as shown in FIG. 7A, a triangular shape as shown in FIG. 7B, or an elliptical shape as shown in FIG. 7C. Alternatively, the separation members 350 can have a circular shape (not shown).

The size of the separation members 350 may be about 1/10 to 10 times the size of blood cells. The width and length of the micro channel 400 may be about 1 to 10 times the size of blood cells. In this case, the blood plasma separator can efficiently separate blood 930, which is introduced into the blood plasma separator by external pumping, into a blood cell concentration liquid 910 and blood plasma 920 without having to use an additional device. The dimensions of the separation members 300 and the micro channel 400, such as width, height, size, and length, can be changed to increase efficiency in separating blood cells and blood plasma.

Meanwhile, as shown in FIG. 5, the outlet 200 can include a blood cell outlet 210 and a blood plasma outlet 220. In this case, a blood cell concentration liquid 910 in which separated blood cells are contained is discharged through the blood cell outlet 210, and blood plasma 920 is discharged through the blood plasma outlet 220. Therefore, the blood cell concentration liquid 910 or the blood plasma 920 can be directly guided to a biosensor without an additional separation process.

The body of the blood plasma separator including the cover substrate 500 and the channel substrate 550, or the separation member 300 or 350 can be formed of one of a plastic material, a silicon material, a glass material, and a rubber material. For example, the plastic material may be one selected from the group consisting of polydimethylsiloxane (PDMS), polymethylmethacrylate (PMMA), polycarbonate (PC), cycloolefin copolymer (COC), polyamide (PA), polyethylene (PE), polypropylene (PP), polyphenylene ether (PPE), polystyrene (PS), polyoxymethylene (POM), polyetheretherketone (PEEK), polytetrafluoroethylene (PTFE), polyvinylchloride (PVC), polyvinylidene fluoride (PVDF), polybutyleneterephthalate (PBT), fluorinatedethylenepropylene (FEP), perfluoralkoxyalkane (PFA) and combinations thereof.

For example, blood can be supplied to the blood plasma separator at a constant or variable flow rate and pressure using a blood supply unit such as a pump connected to the inlet 100 to make flows of blood cells and blood plasma of the blood turbulent so as to increasing efficiency in separating the blood cells and the blood plasma.

Furthermore, the blood plasma separator may further include a chemically treated portion on an inner surface that is chemically treated to be adhesive to blood cells for increasing efficiency in separating blood cells and blood plasma. In addition, complementary capture probe ligands can be coupled to the inner surface of the micro channel 400 for detecting desired substances such as protein.

An analyzer can be disposed at an end of the micro channel 400 or the outlet 200 (or the blood cell outlet 210 or the blood plasma outlet 220) for biochemical reactions or detections using separated blood cells and blood plasma.

For example, the micro channel 400 can be connected to a protein biosensor to detect specific proteins from blood using blood plasma separated from the blood.

When the blood plasma separator is fabricated, the micro channel 400 may be formed in at least one of the cover substrate 500 and the channel substrate 550 of the body through a predetermined process. The predetermined process can be performed using a conventional method such as numerical control (NC) machining, laser ablation, electrical discharge, casting, stereolithography, rapid prototyping, photolithography, hot embossing, and injection molding. When the blood plasma separator is formed using a plastic material, the micro channel 400 can be formed through a hot embossing or an injection molding process for mass production with lower costs.

The cover substrate 500 and the channel substrate 550 can be bonded together using a predetermined method such as hot pressing, adhesion bonding, or ultrasonic welding.

In the blood plasma separator in accordance with the present invention, blood cells can be separated from blood plasma without clotting of the blood cells by confining or separating blood cells using the simple separation members disposed in the micro channel of the substrate.

Therefore, the blood plasma separator cam be easily fabricated and used to automatically separate blood plasma from whole blood by pumping without having to use an additional device. The blood plasma separator of the present invention can be used as a pre-processing unit in an integrated biosensor such as a lap-on-a-chip.

Furthermore, the blood plasma separator of the present invention can be formed using a plastic material for mass production with lower costs. In this case, the blood plasma separator can be conveniently used as a disposable blood plasma separating device.

While the present invention has been described with respect to the specific embodiments, it will be apparent to those skilled in the art that various changes and modifications may be made without departing from the spirit and scope of the invention as defined in the following claims.

What is claimed is:

1. A blood plasma separator for separating blood plasma from blood, the blood plasma separator comprising:
a body;
a micro channel formed in the body to allow blood to pass therethrough;
a separation member formed at the micro channel to make a flow of blood cells or blood plasma of the blood turbulent so as to separate the blood cells and the blood plasma;
an inlet connected to the micro channel and configured to introduce blood into the micro channel; and
an outlet connected to the micro channel and configured to discharge blood from the micro channel.

2. The blood plasma separator of claim 1, wherein the body includes a cover substrate and a channel substrate that are bonded together, and the micro channel is formed on a plane defined by the cover substrate and the channel substrate.

3. The blood plasma separator of claim 1, wherein the micro channel includes a plurality of bent portions to apply a centrifugal force to blood when the blood flows from the inlet to the outlet through the micro channel.

4. The blood plasma separator of claim 1, wherein the micro channel includes a chemically treated portion on an inner surface so as to increase efficiency in separating blood cells and blood plasma.

5. The blood plasma separator of claim 1, wherein the micro channel includes a complementary capture probe ligand on an inner surface for detecting a predetermined protein from blood plasma.

6. The blood plasma separator of claim 1, wherein the separation member is protruded from an inner wall of the micro channel to cause a velocity difference or deflection between flows of blood cells and blood plasma.

7. The blood plasma separator of claim 6, wherein a plurality of separation members is arranged at the micro channel in a blood flow direction, and rows of the separation members face each other.

8. The blood plasma separator of claim 7, wherein the rows of the separation members are symmetric or asymmetric with respect to a centerline of a blood flow.

9. The blood plasma separator of claim 7, wherein the separation members decrease or increase in size in the blood flow direction.

10. The blood plasma separator of claim 6, wherein the separation member has a triangular, rectangular, or semicircular shape.

11. The blood plasma separator of claim 1, wherein the separation member is formed to connect mutually facing inner walls of the micro channel so as to cause a velocity difference or deflection between flows of blood cells and blood plasma.

12. The blood plasma separator of claim 11, wherein a plurality of separation members is arranged at the micro channel in a blood flow direction.

13. The blood plasma separator of claim 12, wherein the separation members include sloped or curved surfaces in the blood flow direction to guide blood cells downward or blood plasma upward.

14. The blood plasma separator of claim 13, wherein the separation members have a triangular, trapezoidal, elliptical, or circular shape.

15. The blood plasma separator of claim 7, wherein the separation members have a size about 1/10 to about 10 times that of blood cells, and the micro channel has a width and length about 1 to about 10 times that of blood cells.

16. The blood plasma separator of claim 12, wherein the separation members have a size about 1/10 to about 10 times that of blood cells, and the micro channel has a width and length about 1 to about 10 times that of blood cells.

17. The blood plasma separator of claim 1, wherein the outlet is divided in such a manner that separated blood cells and blood plasma are independently discharged.

18. The blood plasma separator of claim 1, wherein the body or the separation member is formed of one of a plastic material, a silicon material, a glass material, and a rubber material.

19. The blood plasma separator of claim 1, further comprising an analyzer disposed at an end of the micro channel for performing a biochemical reaction or detection using separated blood cells and blood plasma.

20. The blood plasma separator of claim 1, wherein blood is supplied to the micro channel at a constant or varying flow rate and pressure using a blood supply unit connected to the micro channel to make a flow of blood cells or blood plasma turbulent for facilitating separation of the blood cells and the blood plasma.

21. The blood plasma separator of claim 1, wherein the micro channel is connected to a biosensor for detecting a specific protein from separated blood plasma.

22. A method of separating blood plasma from blood using a blood plasma separator including a body, a micro channel formed in the body to allow blood to pass therethrough, and a separation member formed at the micro channel to make a flow of blood cells or blood plasma of the blood turbulent, the method comprising the step of:
causing blood cells and blood plasma of blood to flow in the micro channel at different velocities or in different deflection directions by using the separation member formed in the micro channel or on an inner wall of the micro channel so as to separate the blood cells and the blood plasma.
